(19) United States
(12) Patent Application Publication
(10) Pub. No.: US 2014/0164972 A1
(43) Pub. Date: Jun. 12, 2014

(54) APPARATUS FOR PROCESSING A SCHEDULE INTERFACE AND METHOD THEREOF

(71) Applicant: LG ELECTRONICS INC., Seoul (KR)

(72) Inventor: Kunwoo LEE, Seoul (KR)

(73) Assignee: LG ELECTRONICS INC., Seoul (KR)

(21) Appl. No.: 13/781,296

(22) Filed: Feb. 28, 2013

(30) Foreign Application Priority Data
Dec. 10, 2012 (KR) 10-2012-0142524

(51) Int. Cl. G06F 3/0484

(52) U.S. Cl. CPC G06F 3/0484
USPC 715/772

(57) ABSTRACT

An apparatus and method for processing an image are disclosed. The present invention includes a processor controlling a schedule interface indicating schedule information of the user to be displayed, wherein the schedule interface comprises a time line bar comprising a current time indicator indicating a current time and at least one time indicator configured to discriminate a time, and an indication window configured to display content of an event occurring on a specific time on the time line bar. The processor controls the time line bar to be displayed on one side of the display panel, controls the indication window to be displayed in a manner of overlapping with a background screen displayed on the display panel, and controls the at least one time indicator and the indication window to be displayed in a manner of being shifted in one direction according to a flow of time.

Pursuant to 35 U.S.C. §119(a), this application claims the benefit of earlier filing date and right of priority to Korean Application No. 10-2012-0142524, filed on Dec. 10, 2012, the contents of which are hereby incorporated by reference herein in their entirety.

### BACKGROUND OF THE INVENTION

1. Field of the Invention

The present invention relates to an apparatus for processing an image and method thereof, in which a display panel and a user input receiving unit configured to receive an input attributed to a user's screen touch action are included. More particularly, the present invention relates to an apparatus for processing a schedule interface and method thereof. Although the present invention is suitable for a wide scope of applications, it is particularly suitable for receiving a user input and then processing user's schedule information in response to the received user input.

2. Discussion of the Related Art

Generally, a touchscreen means a device configured to directly receive an input material via a screen. In particular, when a character displayed on the screen or a specific position on the screen is touched with a human finger or object instead of using a keyboard, the touchscreen obtains the touched position and then performs a specific processing by software.

For instance, the touchscreen includes a touch panel attached to a screen of a general monitor to activate a prescribed function. In particular, the touch panel generates numerous rectangular lattices by enabling invisible infrared rays to flow in top-bottom and right-left directions. If a specific one of the lattices is touched with a fingertip or prescribed object, the touch panel is able to obtain a position of the touched lattice.

If a character or picture information displayed on the screen provided with the touch panel is touched with a finger, the touchscreen recognizes an item selected by a user in response to the touched position on the screen and then enables a command corresponding to the recognized item to be processed by a computer, thereby facilitating a desired information to be obtained. A recently manufactured mobile image processing device including a mobile audio/video receiving device is equipped with such a touchscreen function.

A mobile image processing device is normally used for the purpose of individual usage rather than public usage for multiple users. Hence, the mobile image processing device has a configuration optimized for individual convenience. In particular, if personal schedule information is processed by the mobile image processing device, it may provide a user with an efficient method. However, despite that numerous schedule information management applications are released in the market, a schedule interface capable of enabling a user to recognize and edit schedule information intuitively has not been provided yet.

### SUMMARY OF THE INVENTION

Accordingly, embodiments of the present invention are directed to an apparatus for processing an image and method thereof that substantially obviate one or more problems due to limitations and disadvantages of the related art.

An object of the present invention is to provide a method of processing a schedule interface and an image processing apparatus including a mobile image processing apparatus, by which a user is enabled to recognize and edit schedule information intuitively.

Additional advantages, objects, and features of the invention will be set forth in the disclosure herein as well as the accompanying drawings. Such aspects may also be appreciated by those skilled in the art based on the disclosure herein.

To achieve these objects and other advantages and in accordance with the purpose of the invention, as embodied and broadly described herein, an apparatus for processing an image according to one embodiment of the present invention may include a display panel, a user input receiving unit configured to receive an input by a screen touch action of a user, and a processor controlling a schedule interface indicating a schedule information of the user to be displayed, wherein the schedule interface includes a time line bar including a current time indicator indicating a current time and at least one time indicator configured to discriminate a time, and an indication window configured to display a content of an event occurring on a specific time on the time line bar, wherein the processor controls the time line bar to be displayed on one side of the display panel, wherein the processor controls the indication window to be displayed in a manner of overlapping with a background screen displayed on the display panel, and wherein the processor controls the at least one time indicator and the indication window to be displayed in a manner of being shifted in one direction in accordance with a flow of time.

Preferably, the processor controls the background screen to be displayed in a manner of being pushed in direction of a side opposite to the time line bar displayed side by a region having the time line bar displayed thereon.

Preferably, if a user input of selecting a specific home screen from a plurality of home screens is received by the user input receiving unit, the processor controls an indication window, which is related to an application activated by an activate button provided to the specific home screen selected by the user input, to be displayed in a manner of being linked to a specific time on the time line bar and also controls an indication window, which is related to an application activated by an activate button provided to the home screen other than the selected specific home screen, to be removed.

Preferably, the current time indicator is situated at a center region of the time line bar, the time line bar is partitioned into a 1^{st} region and a 2^{nd} region with reference to the current time indicator, the processor controls the time indicator indicating a past time to be displayed on the 1^{st} region, and the processor controls the time indicator indicating a future time to be displayed on the 2^{nd} region.

Preferably, while the indication window is touched, if a sliding touch action performed in direction of the time line bar displayed side is received by the user input receiving unit, the processor controls the indication window to be removed.

Preferably, if a touch action performed on the indication window is received by the user input receiving unit, the processor controls a content of the indication window to be displayed in a manner of being extended.

Preferably, while a portion of the time line bar is touched, if a sliding touch action performed in direction of a side opposite to the time line bar displayed side is received by the user input receiving unit, the processor controls the time line bar to be displayed in a manner of being enlarged into the whole display panel and also controls a detailed content of the indication window to be displayed within the time line bar.

Preferably, if a pinch-in touch action performed on the time line bar is received by the user input receiving unit, the processor controls the time indicator to be displayed in a manner of being replaced by at least one date indicator configured to discriminate a date.

Preferably, if a pinch-out touch action performed on the time line bar is received by the user input receiving unit, the processor controls the time indicator to be displayed in a manner of being replaced by at least one minute indicator configured to discriminate a minute.

Preferably, if a plurality of indication windows exist in a specific time region on the time line bar, the processor controls a thickness of the time line bar indicating the specific time region to be displayed in a manner of varying in proportion to the number of a plurality of the indication windows.

Preferably, the processor controls the indication window about text, advertisement or schedule information to be displayed in a manner of being linked to a specific time on the time line bar by scanning data and hour information contained in the text, advertisement or schedule information and then sorting out the indication window by the data and hour information.

Preferably, while the indication window of a 1^{st} time region on the time line bar is touched, if an action of dragging the touched indication window to a 2^{nd} time region on the time line bar is received by the user input receiving unit, the processor controls an event schedule of the indication window of the 1^{st} time region to be displayed in a manner of being changed into a time of the 2^{nd} time region.

Preferably, if a sliding touch action performed on the time line bar in direction horizontal to that of the time line bar is received by the user input receiving unit, the processor controls the time indicator to be displayed in a manner of being shifted in a sliding direction of the sliding touch action.

Preferably, while a 1^{st} indication window is touched, if an action of dragging the touched 1^{st} indication window onto a 2^{nd} indication window is received by the user input receiving unit, the processor controls a content of the 1^{st} indication window to be displayed in a manner of being merged with a content of the 2^{nd} indication window.

Preferably, the processor controls the time line bar to be displayed on a right side of the display panel.

More preferably, while the enlarged indication window is touched, if a snatching action performed in one direction is received by the user input receiving unit, the processor controls the indication window containing a content related to that of the enlarged indication window to be displayed only in a manner of being sorted and linked to a specific time on the time line bar.

In another aspect of the present invention, a method of processing an image according to another embodiment of the present invention may include the step of controlling a schedule interface indicating a schedule information of a user to be displayed, wherein the schedule interface includes a time line bar including a current time indicator indicating a current time and at least one time indicator configured to discriminate a time, and an indication window configured to display a content of an event occurring on a specific time on the time line bar and wherein the step of controlling the schedule interface to be displayed includes the steps of controlling the time line bar to be displayed on one side of a display panel, controlling the indication window to be displayed in a manner of overlapping with a background screen displayed on the display panel, and controlling the at least one time indicator and the indication window to be displayed in a manner of being shifted in one direction in accordance with a flow of time.

Accordingly, the present invention provides the following effects and/or advantages.

First of all, according to one embodiment of the present invention, a user is able to intuitively recognize user's schedule information.

Secondly, according to one embodiment of the present invention, a user is able to intuitively edit user's scheduling information.

Thirdly, according to one embodiment of the present invention, a user's action of checking user's schedule information does not interrupt other information or applications provided by an image processing apparatus.

Effects or advantages obtainable from the present invention may be non-limited by the above mentioned effect. And, other unmentioned effects can be clearly understood from the following description by those having ordinary skill in the technical field to which the present invention pertains. It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. The above and other aspects, features, and advantages of the present invention will become more apparent upon consideration of the following description of preferred embodiments, taken in conjunction with the accompanying drawing figures. In the drawings:

FIG. 1 is a diagram of an image processing apparatus for using a schedule interface configured to provide schedule information according to one embodiment of the present invention;

FIG. 2 is a diagram to describe a process for controlling a schedule interface according to one embodiment of the present invention;

FIG. 3 is a diagram of an enlarged time line bar according to one embodiment of the present invention;

FIG. 4 is a diagram of a time line bar to describe a shift of a time indicator on the time line bar according to one embodiment of the present invention;

FIG. 5 is a diagram of a mobile image processing apparatus to describe an operation of a schedule interface in the mobile image processing apparatus according to one embodiment of the present invention;

FIG. 6 is a diagram for a method of manipulating a schedule interface according to one embodiment of the present invention;

FIG. 7 is a diagram for a method of extending an indication window according to one embodiment of the present invention;

FIG. 8 is a diagram for a method of extending a schedule interface according to one embodiment of the present invention;

FIG. 9 is a diagram for a method of changing a time display unit of a time indicator on a time line bar according to one embodiment of the present invention;

FIG. 10 is a diagram for a method of shifting a time on a time line bar according to one embodiment of the present invention;

FIG. 11 is a diagram of a display of a time line bar according to one embodiment of the present invention;

FIG. 12 is a diagram for a method of editing schedule information in a schedule interface according to one embodiment of the present invention;

FIG. 13 is a diagram for an operation of schedule interface according to one embodiment of the present invention;

FIG. 14 is a diagram for an overall summary of a schedule interface according to one embodiment of the present invention; and

FIG. 15 is a block diagram of an image processing apparatus according to one embodiment of the present invention.

### DETAILED DESCRIPTION OF THE INVENTION

Reference will now be made in detail to the preferred embodiments of the present invention, examples of which are illustrated in the accompanying drawings. And, the present invention may be non-limited by the preferred embodiments of the present invention.

First of all, although terminologies used in the present specification are selected from general terminologies used currently and widely in consideration of functions in the present invention, they may be changed in accordance with intentions of technicians engaged in the corresponding fields, customs, advents of new technologies and the like. Occasionally, some terminologies may be arbitrarily selected by the applicant(s). In this case, the meanings of the arbitrarily selected terminologies shall be described in the corresponding part of the detailed description of the invention. Therefore, terminologies used in the present specification need to be construed based on the substantial meanings of the corresponding terminologies and the overall matters disclosed in the present specification rather than construed as simple names of the terminologies.

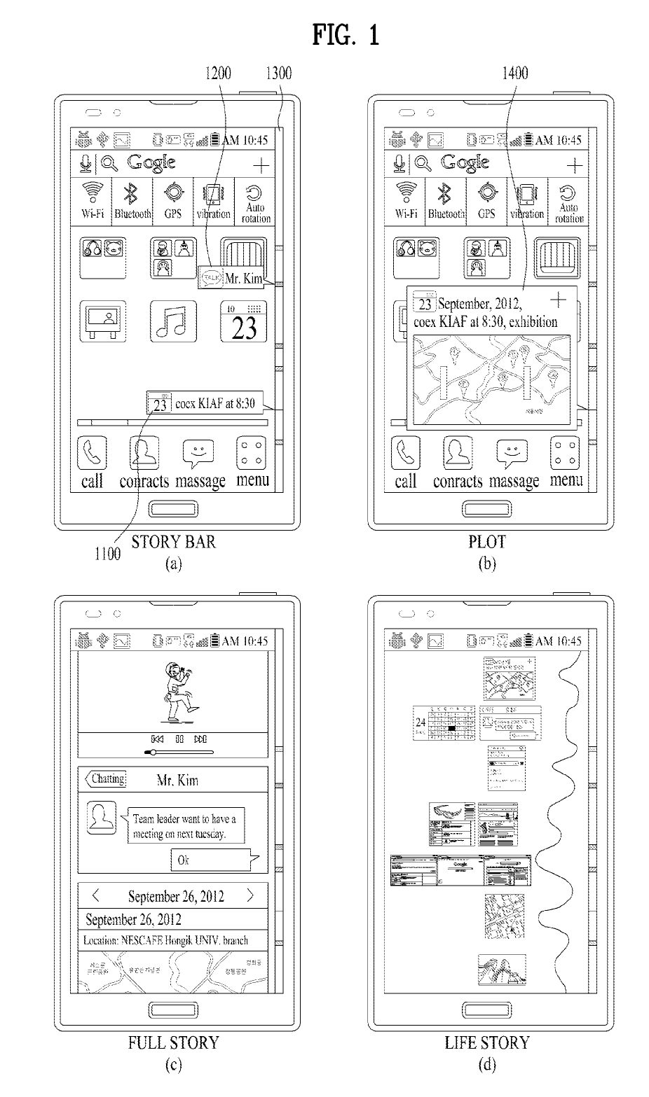

FIG. 1 is a diagram of an image processing apparatus for using a schedule interface configured to provide schedule information according to one embodiment of the present invention.

FIG. 1 (a) shows that a schedule interface is displayed on a mobile image processing apparatus according to one embodiment of the present invention. The schedule interface may include a pair of indication windows 1100 and 1200 and a time line bar 1300.

Schematic information on schedule information can be displayed on each of the indication windows 1100 and 1200. In particular, the indication window 1100/1200 may be able to display a thumbnail of the schedule information, a text type summary of a content, a name of a person having sent a message, and/or time information on a schedule. According to one embodiment of the present invention, the indication window may be displayed in a manner of overlapping with a background screen.

The schedule information may include such a series of information and/or data for user's life management as text message information, daily routine information, album information, chat record, memo record and voice record.

The time line bar 1300 may be displayed on at least one side of a display panel. The time line bar 1300 may be displayed in a manner of not overlapping with a screen (hereinafter named a background screen) already displayed on the display panel. For instance, the image processing apparatus reserves a region for the time line bar on a right side of the display panel and may control the background screen not to be displayed on the reserved region. In particular, when the time line bar is displayed on the right side of the display panel, the background screen may be displayed in a manner of being shifted to the left by the region occupied by the time line bar.

FIG. 1 (b) shows one example of a detailed content of the schedule information indicated by the indication window 1100. According to one embodiment of the present invention, if a user touches the indication window 1100, a detailed content of the scheduling information indicated by the indication window 100 can be enlarged and displayed. For example, the detailed content of the corresponding schedule information may be enlarged and displayed during a predetermined time from a timing point of generating the scheduling information indicated by the indication window 1100. For another example, if a time related to the schedule information (e.g., a scheduled time indicated by the schedule information, etc.) indicated by the indication window 1100 comes, a detailed content of the corresponding schedule information can be enlarged and displayed on the display panel.

FIG. 1 (c) shows a full-screen image of an enlarged schedule interface. The schedule information on the time line bar can be displayed as a full screen. If the schedule interface is enlarged to be displayed as a full screen, a user is able to easily check the detailed content of the schedule information indicated by the schedule interface.

FIG. 1 (d) shows another example of the time line bar. The time line bar may be displayed in a curved shape shown in FIG. 1 (d) as well as in a rectangular shape. In case that a plurality of schedule informations exist on a specific time, the time line bar shown in FIG. 1 (d) is displayed in a manner that its thickness is adjusted to indicate that a plurality of schedules exist on the corresponding time. For instance, if a plurality of schedule informations exist on a specific time, the time line bar may be displayed in a manner that the thickness of the corresponding time zone of the time line bar increases in proportion to the number of the schedule informations existing on the corresponding time. For another instance, the image processing apparatus may be able to control the time line bar in the time zone, in which the schedule information checked as an important schedule information by a user exists, to be displayed as thick. In this case, it is advantageous in that the user is able to intuitively determine the significance of the corresponding schedule.

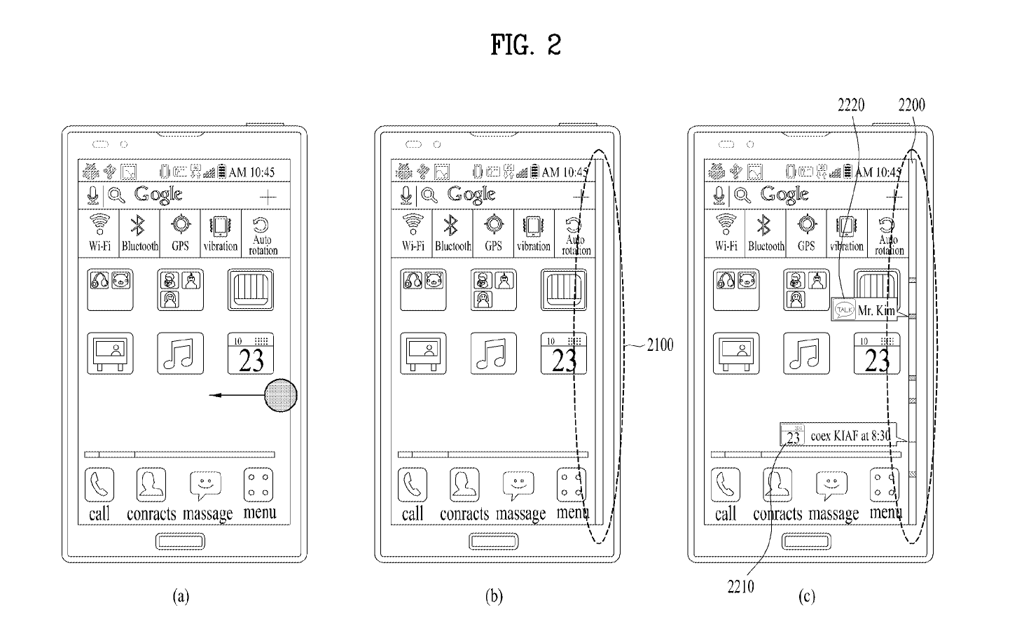

FIG. 2 is a diagram to describe a process for controlling a schedule interface according to one embodiment of the present invention.

Referring to FIG. 2, if a sliding touch action starting from a prescribed side of a display panel toward a center of the display panel is received, an image processing apparatus may be able to control a schedule interface to be displayed on the display panel.

Referring to FIG. 2 (a), if a sliding touch action starting from a right side of the display panel toward the center of the display panel is received, the image processing apparatus reserves a region 2100 for the time line bar on a right side region of the display panel. In this case, a background screen may be displayed in a manner of being pushed to the left side of the display panel. Moreover, the image processing apparatus may be able to control a region amounting to the region 2100 for the time line bar to be removed from the background screen while the position of the background screen is intact.

Although FIG. 2 shows that the schedule interface is displayed on the right side of the display panel, if a user inputs a sliding touch action starting from a left side of the display panel toward the center of the display panel, the schedule interface may be displayed on the left side of the display panel.

FIG. 2 (c) shows that indication windows 2210 and 2220 and a time line bar 2200 included in the schedule interface are displayed. As mentioned in the foregoing description, the time line bar 2200 is displayed on the region 2100 for the time line bar and the indication windows 2210 and 2220 may be displayed in a manner of overlapping with the background screen.

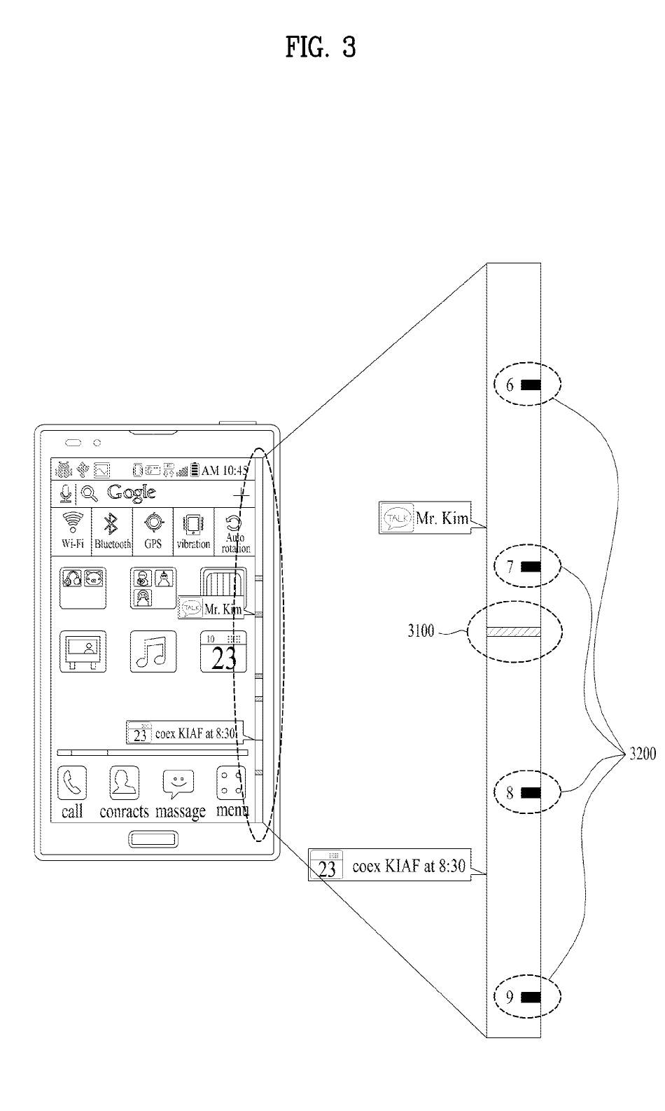

FIG. 3 is a diagram of an enlarged time line bar according to one embodiment of the present invention.

Referring to FIG. 3, a time line bar according to one embodiment of the present invention may include a current time indicator 3100 and/or a time indicator 3200.

The current time indicator 3100 can have any configuration to indicate a current time. For instance, the current time indicator 3100 may be displayed on the time line bar in a manner of indicating a region corresponding to a current hour, as shown in FIG. 3. For another instance, the current time indicator 3100 indicates a region indicating a current hour on the time line bar and is also able to display information on the current hour.

The time indicator 3200 specifies a time on the time line bar. In the example shown in FIG. 3, the time indicator is represented by hour unit. Moreover, a time indicator by minute unit or day unit may be included in the time line bar. The time indicator can be displayed in a manner of reflecting a flow of time. For instance, a position of the time indicator may be changed in accordance with the flow of time. Alternatively, a time indicated by the time indicator may be changed in accordance with the flow of time. Alternatively, a position of the time indicator and a time indicated by the time indicator may be changed together in accordance with the flow of time.

According to one embodiment shown in FIG. 3, schedule information between 6 P.M. and 9 P.M. is displayed on the time line bar. Each time indicator indicating 6 P.M., 7 P.M., 8 P.M or 9 P.M. can move in top end direction on the time line bar in accordance with the follow of time. In case that the time indicator indicating 6 P.M. disappears from the time line bar, a time indicator indicating 10 P.M. may be newly created from a bottom end of the time line bar.

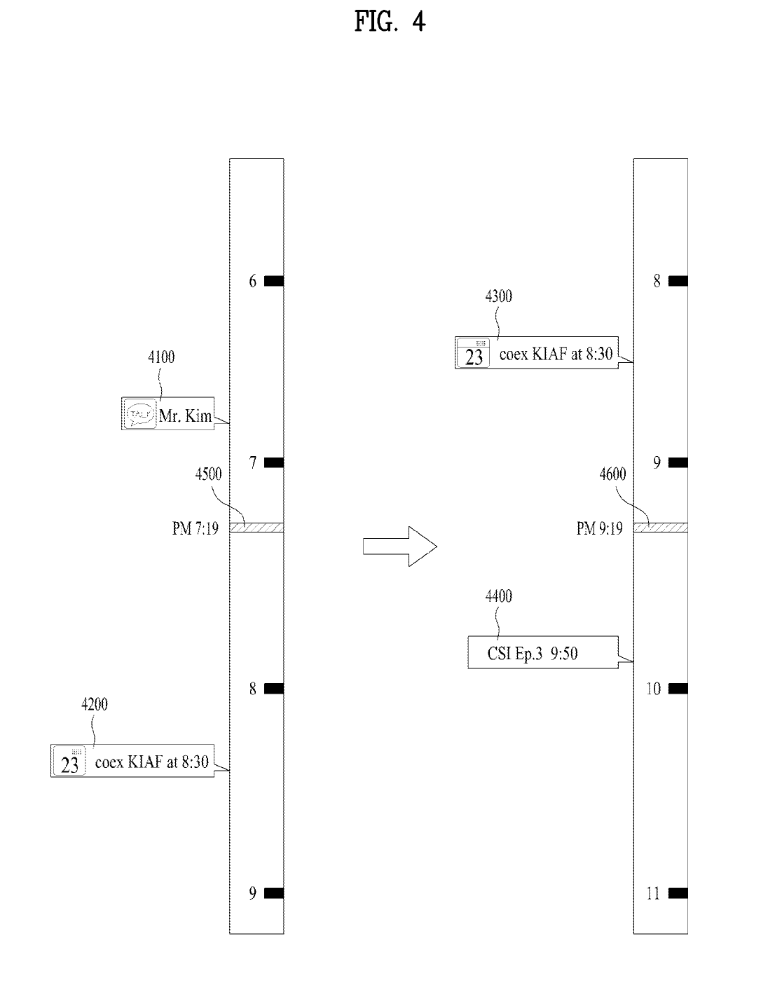

FIG. 4 is a diagram of a time line bar to describe a shift of a time indicator on the time line bar according to one embodiment of the present invention.

Referring to FIG. 4, in case that a current time indicator 4500 indicates 7:19 PM, an indication window 4100 for a messenger content reception occurring between 6 PM and 7 PM is displayed above the current time indicator 4500. An indication window 4200 for a meeting scheduled at 8:30 PM is displayed below the current time indicator 4500. If a current time becomes 9:19 PM in accordance with the follow of time, Since 8:30 PM is already past schedule, the meeting schedule indication window 4300 scheduled at 8:30 PM is shifted and displayed above the current time indicator 4600. And, the indication window 4100 other than the time region displayed on the time line bar is removed. Moreover, a new schedule indication window 4400 scheduled at 9:50 PM is created and displayed below the current time indicator 4600.

According to one embodiment of the present invention, each time indicator can be shifted to a top end part of a time line bar from a bottom end part of the time line bar in accordance with the follow of time. For instance, the time indicator can be shifted on the time line bar by minute unit. For another instance, the time indicator can be shifted in a manner of updated by 10-minute unit, 20=minute unit or 30-minute unit. Alternatively, a time indicated by the time indicator can be changed while a position of the time indicator on the time line bar is not changed. In this case, the time indicator can be updated by hour unit.

An interval of time indicated by a time indicator on a time line bar or an update cycle for a shift of the time indicator on the time line bar can be adjusted in accordance with user's settings.

If a time indicator on a time line bar is changed in accordance with the follow of time, a displayed position of an indication window is changed in accordance with a changing time. Hence, a user is able to intuitively discriminate a past schedule information and a future schedule information from each other with reference to a current time. Moreover, if a schedule to be executed in the near future is displayed with reference to a current time, user's schedule management can be facilitated.

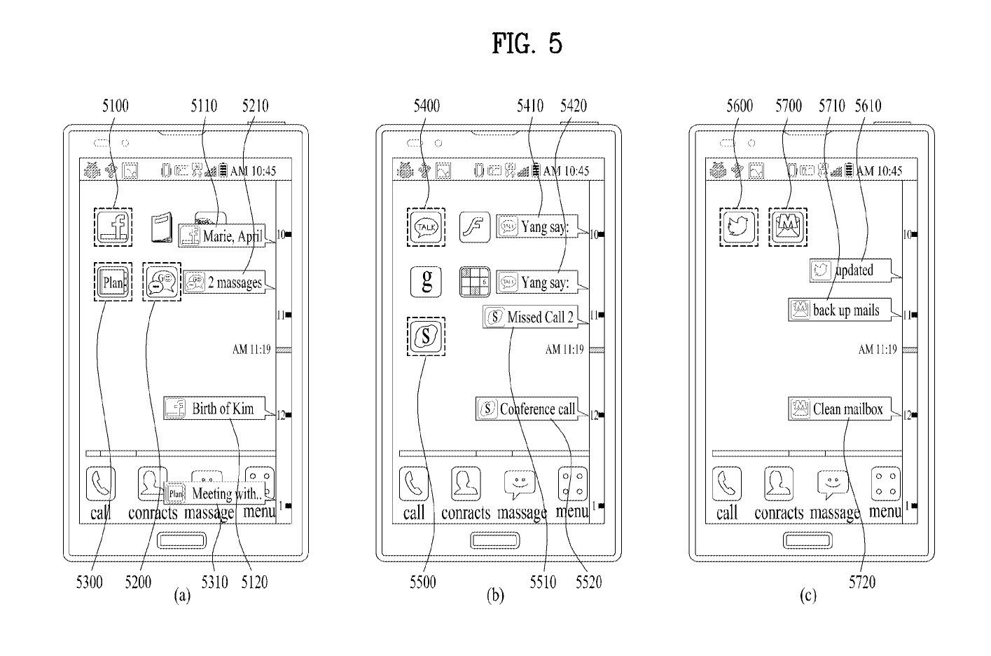

FIG. 5 is a diagram of a mobile image processing apparatus to describe an operation of a schedule interface in the mobile image processing apparatus according to one embodiment of the present invention.

Referring to FIG. 5, a mobile image processing apparatus may be able to have a plurality of home screens in general. In this case, the home screen means the screen on which at least one icon for activating an application installed on the mobile image processing apparatus is displayed. And, an icon displayed on each of a plurality of the home screens may be changed in accordance with user's settings.

According to one embodiment of the present invention, an indication window related to an application activating icon displayed on a home screen can be displayed via a schedule interface. For instance, when a home screen is changed, if a different application activating icon is displayed, indications windows on a schedule interface can be changed into an indication window related to the corresponding application activating icon. By this method, user's recognition on the schedule information can be prevented from being interrupted due to a plurality of indication windows complicatedly displayed on a time line bar. Moreover, since a user is able to sort out and display schedule informations in accordance with user's reference, it is advantageous in activating schedule management intuitively.

In the example shown in FIG. 5, a 1^{st} home screen shown in FIG. 5 (a), a 2^{nd} home screen shown in FIG. 5 (b) and a 3^{rd} home screen shown in FIG. 5 (c) are used by a mobile image processing apparatus.

In the 1^{st} home screen, a Facebook application activating icon 5100, a message application activating icon 5200 and a diary application activating icon 5300 are included. Hence, when a user uses the 1^{st} home screen, a schedule interface may be able to display indication windows 5110 and 5120 related to a Facebook application, an indication window 5210 related to a message application and an indication window 5310 related to a diary application only.

In the 2^{nd} home screen, a messenger application activating icon 5400 and a Skype application activating icon 5500 are included. Hence, when a user changes the 1^{st} home screen into the 2^{nd} home screen, the schedule interface may be able to display indication windows 5410 and 5420 related to a messenger application and indication windows 510 and 520 related to a Skype application only.

In the 3^{rd} home screen, a Twitter application activating icon 5600 and a mail application activating icon 5700 are included. Hence, when a user changes the 1^{st} home screen or the 2^{nd} home screen into the 3^{rd} home screen, the schedule interface may be able to display an indication window 5610 related to a Twitter application and indication windows 5710 and 5720 related to a mail application only.

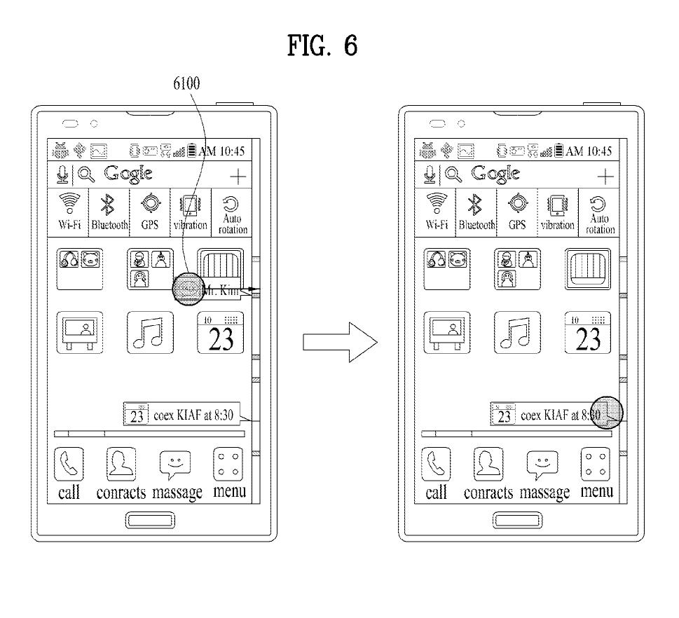

FIG. 6 is a diagram for a method of manipulating a schedule interface according to one embodiment of the present invention.

Referring to FIG. 6, an indication window 6100 is the indication window existing above a current time indicator and relates to a past occurring schedule information. Hence, when a user performs a processing on the schedule information, the user may think that the corresponding indication window needs not to be further displayed. In this case, it may be necessary to remove the corresponding indication window from the display panel by a simple action.

According to one embodiment of the present invention, while a specific indication window is touched, if a user input of a sliding touch action performed on the corresponding indication window in time line bar direction is received, an image processing apparatus may control the corresponding indication window to be removed from the display.

For instance, while a user touches the indication window 6100, if the user inputs a sliding touch in direction of a side on which a time line bar is displayed, the corresponding indication window 6100 is removed from the display panel.

Therefore, it is advantageous in that such a method enables the user to intuitively edit the schedule information.

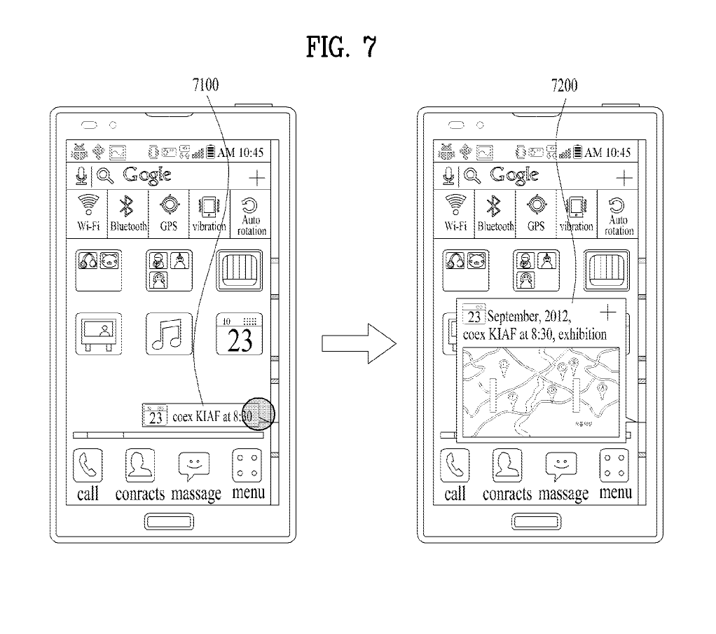

FIG. 7 is a diagram for a method of extending an indication window according to one embodiment of the present invention.

Referring to FIG. 7, a user may need to check what is a detailed content indicated by an indication window displayed on a schedule interface. Hence, the detailed content of the schedule information other than a summary content of the schedule information indicated by the indication window may be necessary.

In case that an image processing apparatus receives a user's input of touching an indication window 7100, the image processing apparatus may be able to display a detailed content of schedule information in a manner of extending the indication window 7100.

The detailed content of the schedule information may include information on a place related to a schedule, information on a note content related to the schedule and/or information on time/date related to the schedule.

According to the present invention, it is advantageous in that a user is cable to obtain a detailed item of schedule information by a simple indication window touching action without activating a separate application.

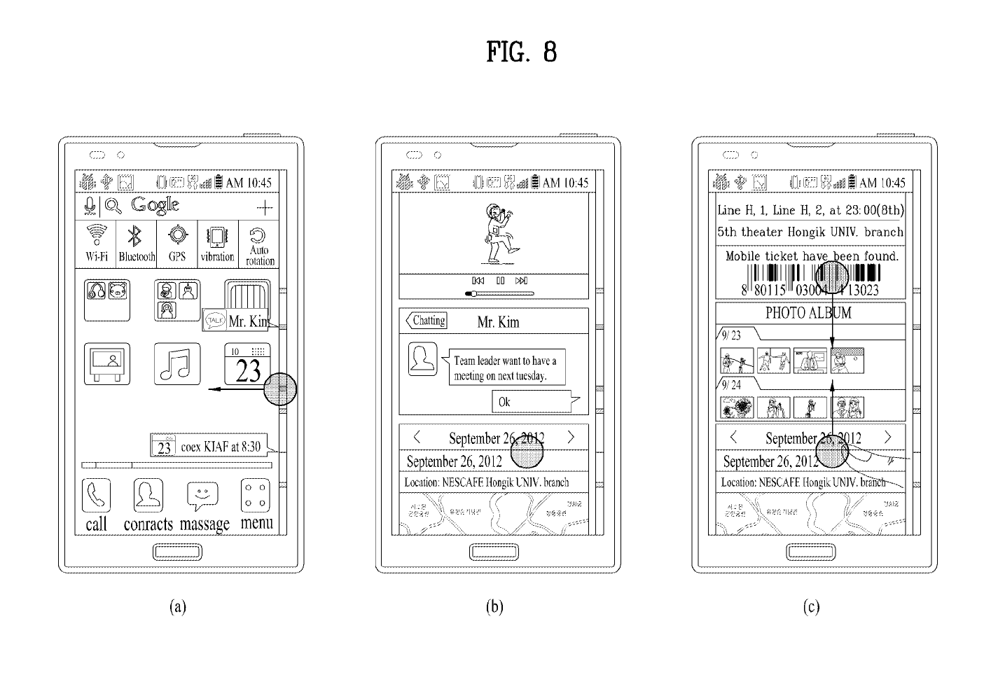

FIG. 8 is a diagram for a method of extending a schedule interface according to one embodiment of the present invention.

Referring to FIG. 8 (a), while a time line bar is touched, if an input of a sliding touch performed in direction opposite to that of a side, on which the time line bar is situated, is received, an image processing apparatus may be able to extend a schedule interface into a full screen of a display panel.

A user may attempt to check detailed contents of a plurality of indication windows displayed on the time line bar at a time. In this case, if the schedule interface is extended into a full screen, the user may be able to confirm the detailed contents of the schedule information.

Referring to FIG. 8 (b), while apportion of the extended schedule interface is touched, if an input of a sliding touch performed in top or bottom direction is received, the image processing apparatus may be able to display the detailed contents of the schedule information by a scroll in response to the direction of the sliding touch.

Referring to FIG. 8 (c), while two point on the extended schedule interface are touched, if a pinch-in action is received, the image processing apparatus may control the detailed contents of the schedule information by hour unit to be displayed in a manner of being changed into the detailed contents of the schedule information by day unit.

If a user attempts to view a plurality of photos saved in a photo album by sorting out the photos not by hour unit but by day unit, the user may be able to view the photos sorted out by day unit by inputting a pinch-in action to a region in which the detailed contents related to the photo album exist.

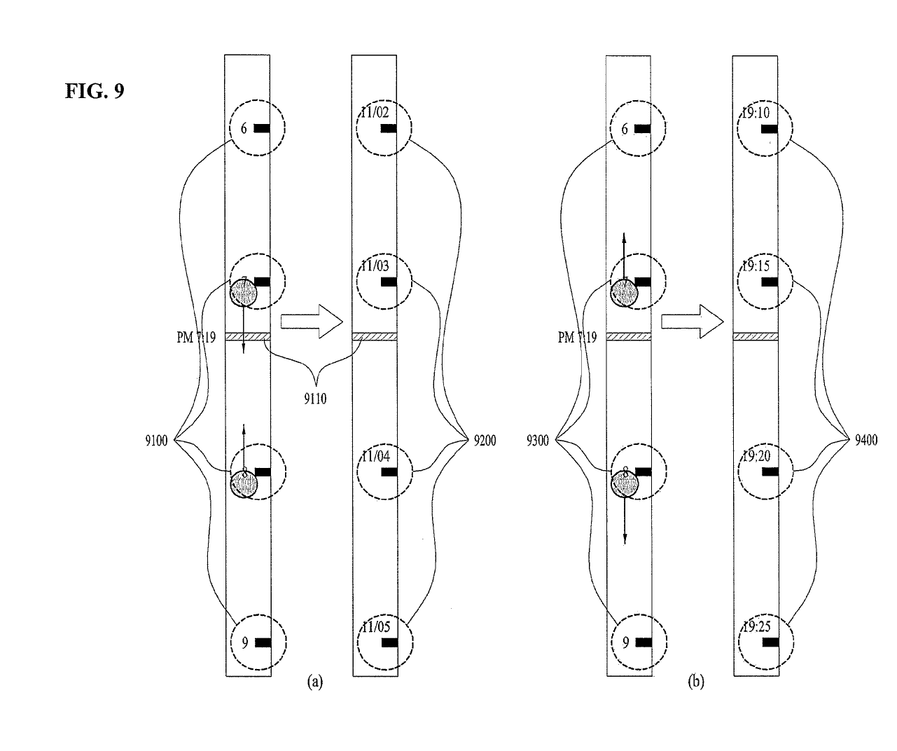

FIG. 9 is a diagram for a method of changing a time display unit of a time indicator on a time line bar according to one embodiment of the present invention.

Referring to FIG. 9, if a pinch-in action on a time line bar is received, an image processing apparatus may control a time indicator to be displayed in a manner that a hour unit indicated by the time indicator is changed into a day unit. In this case, the day-unit changed time indicator 9200 may be named a day indicator 9200. In doing so, the image processing apparatus may control an indication window, which is linked to hours included in a period indicated by the day indicator 9200, to be displayed.

Referring to FIG. 9 (a), if the image processing apparatus receives a pinch-in action on a time line bar including a time indicator 9100 displayed by hour unit, the corresponding time indicator 9100 is changed into a time indicator 9200 by day unit. A current time indicator 9110 shown in FIG. 9 (a) indicates ‘7:19 PM, November 3’.

If a pinch-in action on the time line bar is received, the image processing apparatus may control the time indicator to be displayed in a manner of changing the hour unit of the time indicator 9300 into a minute unit. The minute-unit changed time indicator 9400 may be named a minute-unit indicator 9400. In this case, the image processing apparatus may control an indication window, which is related to the hour included in the period indicated by the minute-unit indicator 9400, to be displayed. In doing so, the image processing apparatus may control an indication window, which fails to be included in the period indicated by the minute-unit indicator 9400, to be removed from the display.

Referring to FIG. 9 (b), if the image processing apparatus receives a pinch-out action on the time line bar including a time indicator 9300 displayed by hour unit, the corresponding hour indicator 9300 is changed into a time indicator 9400 for discrimination by minute unit.

In the description with reference to FIG. 9, the pinch-in action may include the following action. First of all, while at least two points on a touchscreen are touched, a sliding action is performed in direction of narrowing down a space between the touched at least two points. On the contrary, the pinch-out action may include the following action. First of all, while at least two points on a touchscreen are touched, a sliding action is performed in direction of widening a space between the touched at least two points.

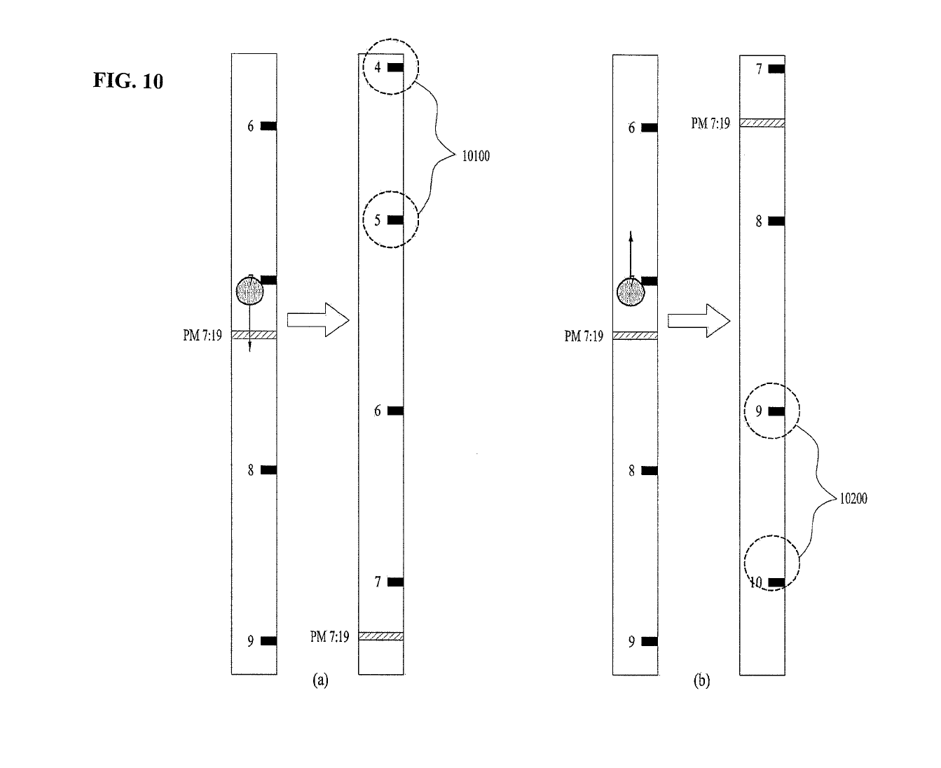

FIG. 10 is a diagram for a method of shifting a time on a time line bar according to one embodiment of the present invention.

Referring to FIG. 10 (a), while a prescribed point on a time line bar is touched, if a sliding action performed in bottom direction is received, an image processing apparatus may control a current time indicator and a time indicator to be displayed on the time line bar in a manner of being shifted in the sliding direction. In accordance with the shifted direction, a new time indicator 10100 may be displayed. The image processing apparatus may control an indication window, which is linked to the time included in the period indicated by the time indicator, to be displayed.

Referring to FIG. 10 (b), while a prescribed point on a time line bar is touched, if a sliding action performed in top direction is received, an image processing apparatus may control a current time indicator and a time indicator to be displayed on the time line bar in a manner of being shifted in the sliding direction. In accordance with the shifted direction, a new time indicator 10200 may be displayed. The image processing apparatus may control an indication window, which is linked to the time included in the period indicated by the time indicator, to be displayed.

According to one embodiment mentioned in the above description, a user shifts a time indicated by a time line bar and has an advantage in obtaining the past or future schedule information that was not displayed on the time line bar.

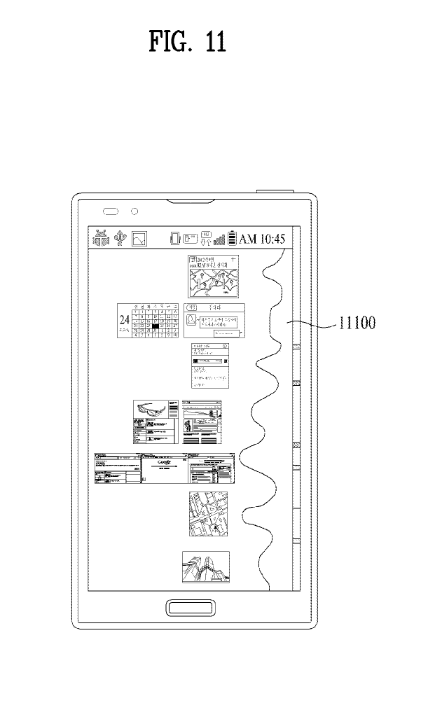

FIG. 11 is a diagram of a display of a time line bar according to one embodiment of the present invention.

Referring to FIG. 11, the time line bar of the schedule interface mentioned in the foregoing description is configured in rectangular or line shape, by which a shape or type of the time line bar is non-limited. And, a time line bar 11100 shown in FIG. 11 may include a curved line shape.

According to one embodiment, a plurality of schedule informations may be generated from a specific time region on a time line bar, whereby a plurality of indication windows may exist. In this case, an image processing apparatus may be able to intuitively indicate that at least one indication window exists on the corresponding time by adjusting thickness of a corresponding time region on the time line bar. For instance, the image processing apparatus may be able to display the time line bar in a manner of increasing the thickness of the time line bar regions indicating the time regions in which the corresponding indication windows exist, respectively, in proportion to the increasing number of the indication windows.

According to another embodiment, the image processing apparatus may be able to control the time line bar to be displayed in a manner that the time line bar thickness of the time region, in which the indication window related to the schedule information important to a user exists, is increased. Hence, the user is able to intuitively recognize such schedule information as an important appointment and the like.

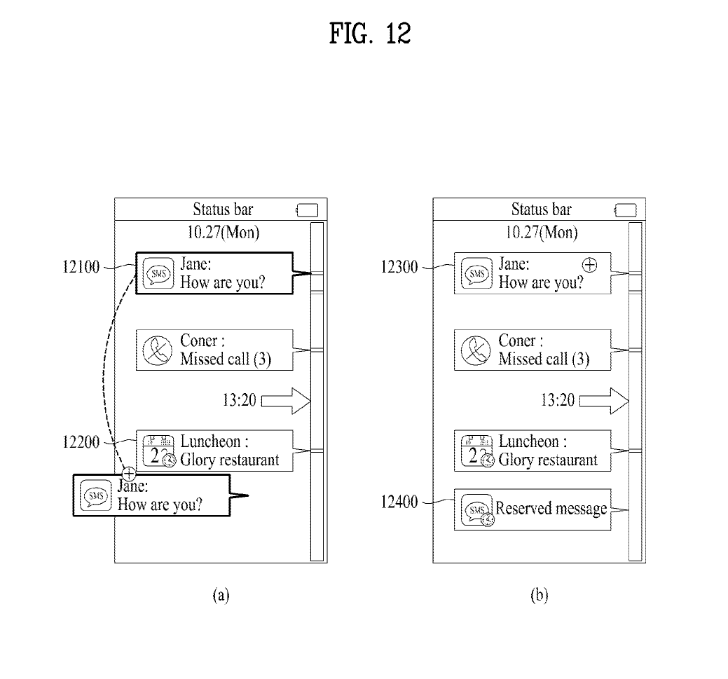

FIG. 12 is a diagram for a method of editing schedule information in a schedule interface according to one embodiment of the present invention.

First of all, while a 1^{st} indication window of a schedule interface is touched, if a user input action of dragging the 1^{st} indication window to a 2^{nd} indication window is received, an image processing apparatus may be able to control a content of schedule information of the 1^{st} indication window to merge with a content of schedule information of the 2^{nd} indication window.

Moreover, a user may be able to edit schedule information in a manner that a specific schedule information can be processed later. While an indication window of a 1^{st} time region is touched, if an input action of dragging the indication window to a 2^{nd} time region on a time line bar is received, an image processing apparatus may be able to control the schedule information indicated by the corresponding indication window to be modified into a time of the 2^{nd} time region.

Referring to FIG. 12, an indication window 12100 indicating information on a message of Jane may be removed from a schedule interface if a prescribed time expires. In doing so, if a reply to the message received from Jane is not sent promptly, a user may forget to make a reply to the message of Jane. Hence, the user needs to be reminded of making the reply to the message of Jane by simply editing schedule information displayed on the schedule interface. For instance, a user may need to be reminded of a content of a message chat with Jane for a dinner appointment with Jane at Glory Restaurant. In this case, it may be necessary to manage an indication window containing the content of the message chat with Jane in a manner that the message chat content contained indication window is merged with an indication window indicating the dinner appointment schedule with Jane.

Referring to FIG. 12 (a), in case of receiving an action of dragging the indication window 12100 indicating the information on the message of Jane onto an indication window 12200 indicating the information on the dinner appointment with Jane, the image processing apparatus may be able to control the schedule information of the indication window 12200 and the schedule information of the indication window 12100 to be merged with each other. Hence, when the user checks the detailed content of the schedule information of the indication window 12200, the user may be able to check the content of the message chat with Jane, which is the schedule information of the indication window 12100, as well.

Referring to FIG. 12 (b), in case of receiving an action of dragging an indication window 12300 indicating information on a message of Jane onto a different time region on a time line bar, an image processing apparatus may control an indication window 12400 including schedule information included in the indication window 12300 to be created from the corresponding time region. Hence, a user is able to make a reservation for the information on the message of Jane to be checked in the future using the indication window 12400.

Therefore, according to the present invention, a user is able to intuitively edit/merge schedule informations.

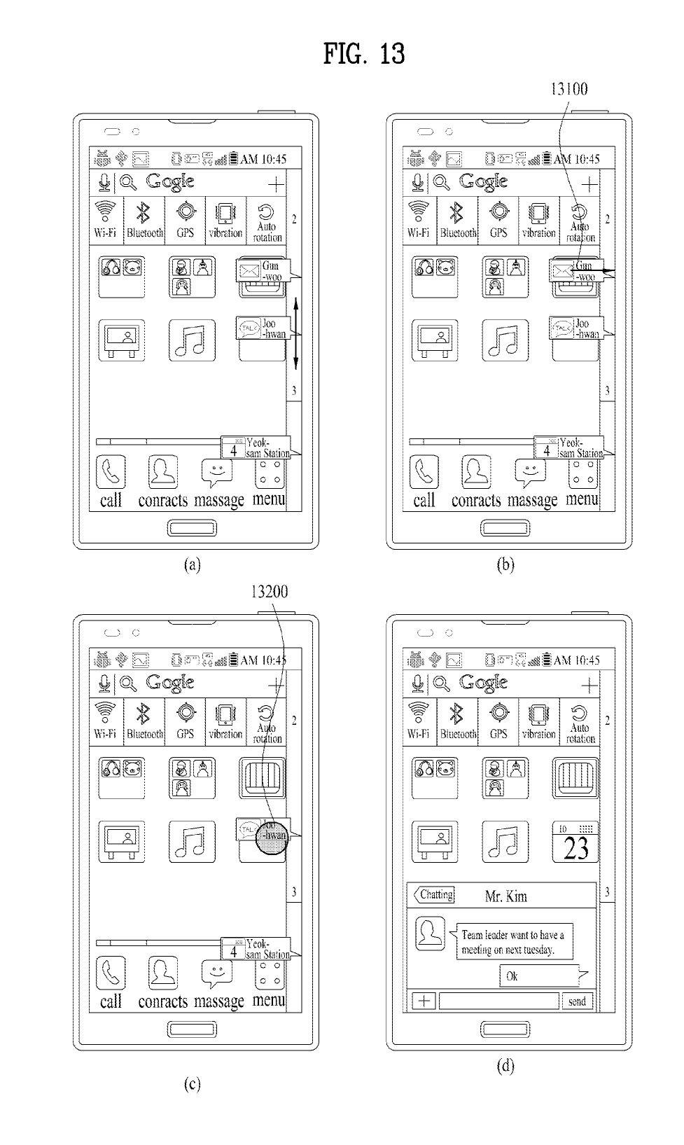

FIG. 13 is a diagram for an operation of schedule interface according to one embodiment of the present invention.

Referring to FIG. 13 (a), if a sliding touch performed in top or bottom direction on a time line bar is received as a user input, an image processing apparatus shifts and displays an indication window, a current time indicator on the time line bar and a time indicator on the time line bar in accordance with direction of the sliding touch. By inputting this action, a user is able to check past or future schedule information failing to be displayed on a schedule interface.

Referring to FIG. 13 (b), while an indication window 13100 is touched, if a user input of a sliding action performed in a side direction of the display panel, on which the time line bar exists, is received, the image processing apparatus removes the corresponding indication window 13100. Hence, the image processing apparatus provides the schedule interface from which the indication window 13100 is removed, as shown in FIG. 13 (c). Thus, the user is able to remove an unnecessary indication window from the schedule interface by inputting this action.

If the image processing apparatus receives a user input of touching an indication window 13200 [FIG. 13 (c)], the image processing apparatus controls a detailed content of schedule information, which is indicated by the corresponding indication window, to be displayed in a manner of being extended [FIG. 13 (d)]. Thus, the user is able to check the detailed content of the scheduling information indicated by the indication window by inputting this action.

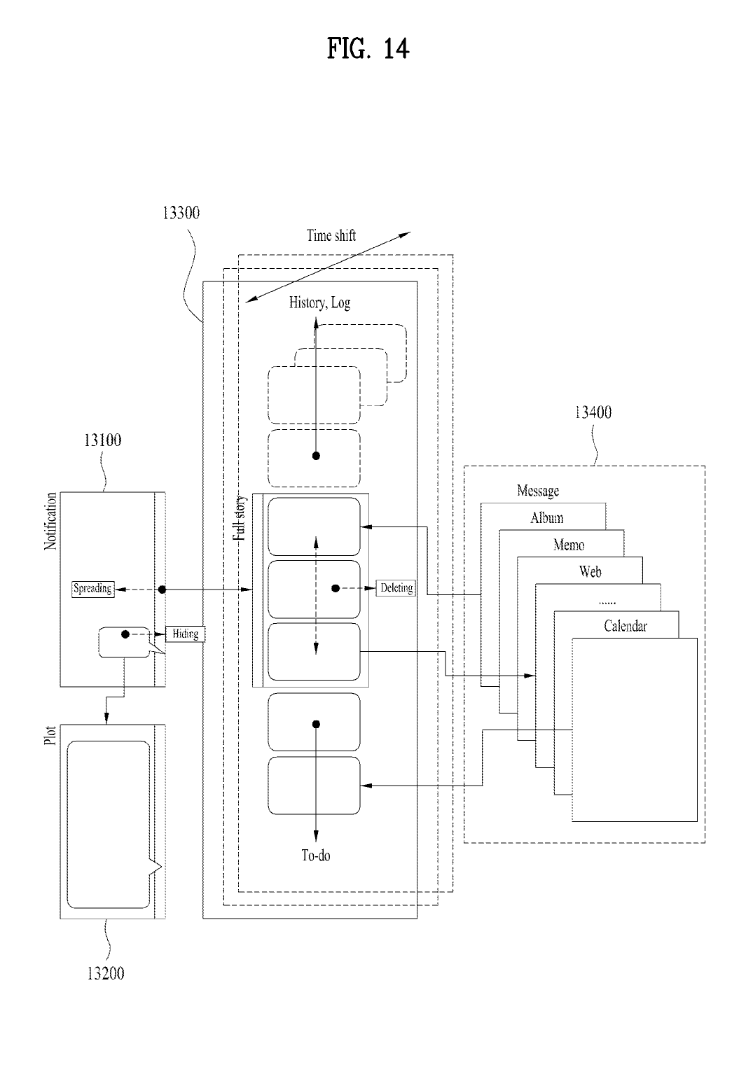

FIG. 14 is a diagram for an overall summary of a schedule interface according to one embodiment of the present invention.

Referring to FIG. 14, a time line bar of a schedule interface 13100 may be situated on one side of a display screen and may include an indication window.

If a user input of touching the indication window is received, a detailed content of schedule information indicated by the corresponding indication window is displayed on a schedule interface 13200.

If a user input of dragging the time line bar in direction of a side opposite to the time line bar existing side is received, the schedule interface is enlarged to be displayed on a whole display screen. And, the enlarged schedule interface 13300 displays the detailed content of the schedule information indicated by the indication window.

Schedule information 13400 containable in the schedule interface may include message information, album information, memo information web related information, date related information and/or diary information.

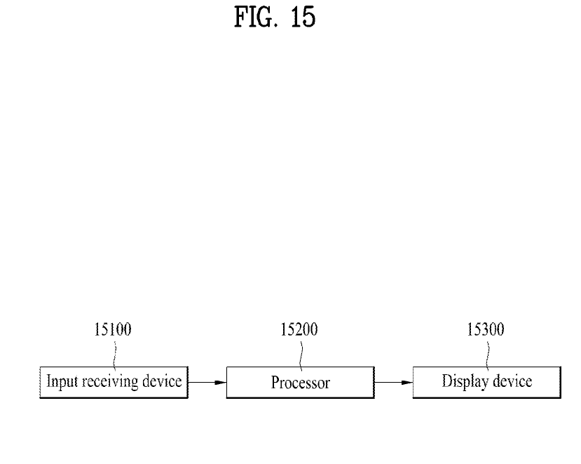

FIG. 15 is a block diagram of an image processing apparatus according to one embodiment of the present invention.

Referring to FIG. 15, an image processing apparatus may include an input receiving unit 15100, a processor 15200 and/or a display unit 15300.

The image processing apparatus may further include a communication module (not shown in the drawing) configured for mobile communication, a storage unit (not shown in the drawing) configured for data storage, and/or a network interface (not shown in the drawing) configured for wire/wireless network.

The input receiving unit 15100 receives a user's screen touch input. The input receiving unit 15100 receives a user's input unit via one of other input buttons provided to the image processing apparatus. The input receiving unit 15100 receives a user's input via the mobile communication. And, the input receiving unit 15100 receives a user's input via the wire/wireless network.

The input receiving unit 15100 may be able to receive the user input actions mentioned in the foregoing description with reference to the accompanying drawings.

The processor 15200 may be able to control operations of the image processing apparatus. The processor 15200 may be able to process the user input received by the input receiving unit 15100. The processor 15200 may control the display unit 15300 to adjust a display.

As mentioned in the foregoing description with reference to the accompanying drawings, the processor 15200 is responsible for overall controls to activate the schedule interface.

The display unit 15300 plays a role in visually displaying data processed by the image processing apparatus. The display unit 15300 provides a display screen for the schedule interface under the control of the processor 15200.

Although the units of the image processing apparatus shown in FIG. 15 are schematically described, the units are provided to perform the operations related to the schedule interfaces described with reference to FIGS. 1 to 14. Therefore, it is apparent to those skilled in the art that the contents described with reference to FIGS. 1 to 14 are applicable to the units shown in FIG. 15.

Although the description of the present invention is explained with reference to each of the accompanying drawings for clarity, it is possible to design new embodiment(s) by merging the embodiments shown in the accompanying drawings with each other. And, if a recording medium readable by a computer, in which programs for executing the embodiments mentioned in the foregoing description are recorded, is designed in necessity of those skilled in the art, it may belong to the scope of the appended claims and their equivalents.

An apparatus and method according to the present invention may be non-limited by the configurations and methods of the embodiments mentioned in the foregoing description. And, the embodiments mentioned in the foregoing description can be configured in a manner of being selectively combined with one another entirely or in part to enable various modifications.

Accordingly, the present invention provides the following effects and/or advantages.

First of all, according to one embodiment of the present invention, a user is able to intuitively recognize user's schedule information.

Secondly, according to one embodiment of the present invention, a user is able to intuitively edit user's scheduling information.

Thirdly, according to one embodiment of the present invention, a user's action of checking user's schedule information does not interrupt other information or applications provided by an image processing apparatus.

It will be appreciated by those skilled in the art that the present invention can be specified into other form(s) without departing from the spirit or scope of the inventions.

In addition, an image processing method according to the present invention can be implemented with processor-readable codes in a processor-readable recording medium provided to a network device. The processor-readable medium may include all kinds of recording devices capable of storing data readable by a processor. The processor-readable medium may include one of ROM, RAM, CD-ROM, magnetic tapes, floppy discs, optical data storage devices, and the like for example and also include such a carrier-wave type implementation as a transmission via Internet. Furthermore, as the processor-readable recording medium is distributed to a computer system connected via network, processor-readable codes can be saved and executed according to a distributive system.

It will be appreciated by those skilled in the art that various modifications and variations can be made in the present invention without departing from the spirit or scope of the inventions. Thus, it is intended that the present invention covers the modifications and variations of this invention provided they come within the scope of the appended claims and their equivalents.

Both apparatus and method inventions are mentioned in this specification and descriptions of both of the apparatus and method inventions may be complementarily applicable to each other.

What is claimed is:

1. An apparatus for processing an image, comprising:
a display panel;
a user input receiving unit configured to receive an input by a screen touch action of a user; and
a processor controlling a schedule interface indicating schedule information of the user to be displayed,
wherein the schedule interface comprises a time line bar comprising a current time indicator indicating a current time and at least one time indicator configured to separate time, and an indication window configured to display a content of an event occurring on a specific time on the time line bar,
wherein the processor controls the time line bar to be displayed on one side of the display panel,
wherein the processor controls the indication window to be displayed in a manner of overlapping with a background screen displayed on the display panel, and
wherein the processor controls the at least one time indicator and the indication window to be displayed in a manner of being shifted in one direction in accordance with a flow of time.

2. The apparatus of claim 1, wherein the processor controls the background screen to be displayed in a manner of being pushed in a direction of a side opposite to the displayed time line bar by a region having the time line bar displayed thereon.

3. The apparatus of claim 1, wherein if a user input of selecting a specific home screen from a plurality of home screens is received by the user input receiving unit, the processor controls an indication window, which is related to an application activated by an activate button provided to the specific home screen selected by the user input, to be displayed in a manner of being linked to a specific time on the time line bar and also controls an indication window, which is related to an application activated by an activate button provided to the home screen other than the selected specific home screen, to be removed.

4. The apparatus of claim 1, wherein the current time indicator is located at a center region of the time line bar, wherein the time line bar is partitioned into a first region and a second region with reference to the current time indicator, wherein the processor controls the time indicator indicating a past time to be displayed on the first region, and wherein the processor controls the time indicator indicating a future time to be displayed on the second region.

5. The apparatus of claim 1, wherein while the indication window is touched, if a sliding touch action performed in direction of the time line bar displayed side is received by the user input receiving unit, the processor controls the indication window to be removed.

6. The apparatus of claim 1, wherein if a touch action performed on the indication window is received by the user input receiving unit, the processor controls a content of the indication window to be displayed in a manner of being extended.

7. The apparatus of claim 1, wherein while a portion of the time line bar is touched, if a sliding touch action performed in direction of a side opposite to the time line bar displayed side is received by the user input receiving unit, the processor controls the time line bar to be displayed in a manner of being extended into a full display panel and also controls a detailed content of the indication window to be displayed within the time line bar.

8. The apparatus of claim 1, wherein if a pinch-out touch action performed on the time line bar is received by the user input receiving unit, the processor controls the time indicator to be displayed in a manner of being replaced by at least one date indicator configured to separate a date.

9. The apparatus of claim 1, wherein if a pinch-in touch action performed on the time line bar is received by the user input receiving unit, the processor controls the time indicator to be displayed in a manner of being replaced by at least one minute indicator configured to separate a minute.

10. The apparatus of claim 1, wherein if a plurality of indication windows exist in a specific time region on the time line bar, the processor controls a thickness of the time line bar indicating the specific time region to be displayed in a manner by varying in proportion to the number of a plurality of the indication windows.

11. The apparatus of claim 1, wherein the processor controls the indication window for at least one of text, advertisement and schedule information to be displayed in a manner of being linked to a specific time on the time line bar by scanning data and hour information contained in the at least one of text, advertisement and schedule information and then sorting out the indication window by the data and hour information.

12. The apparatus of claim 1, wherein while the indication window of a first time region on the time line bar is touched, if an action of dragging the touched indication window to a second time region on the time line bar is received by the user input receiving unit, the processor controls an event schedule of the indication window of the first time region to be displayed in a manner of being changed into a time of the second time region.

13. The apparatus of claim 1, wherein if a sliding touch action performed on the time line bar in a horizontal direction to that of the time line bar is received by the user input receiving unit, the processor controls the time indicator to be displayed in a manner of being shifted in a sliding direction of the sliding touch action.

14. The apparatus of claim 1, wherein while a first indication window is touched, if an action of dragging the touched first indication window onto a second indication window is received by the user input receiving unit, the processor controls a content of the first indication window to be displayed in a manner of being merged with a content of the second indication window.

15. The apparatus of claim 1, wherein the processor controls the time line bar to be displayed on a right side of the display panel.

16. The apparatus of claim 6, wherein while the extended indication window is touched, if a snatching action performed in one direction is received by the user input receiving unit, the processor controls the indication window containing a content related to that of the extended indication window to be displayed only in a manner of being sorted and linked to a specific time on the time line bar.

17. A method of processing an image, comprising the step of controlling a schedule interface indicating a schedule information of a user to be displayed,
wherein the schedule interface comprises a time line bar comprising a current time indicator indicating a current time and at least one time indicator configured to separate a time, and an indication window configured to display a content of an event occurring on a specific time on the time line bar and
wherein the step of controlling the schedule interface to be displayed comprises the steps of controlling the time line bar to be displayed on one side of a display panel, controlling the indication window to be displayed in a manner of overlapping with a background screen displayed on the display panel, and controlling the at least one time indicator and the indication window to be displayed in a manner of being shifted in one direction in accordance with a flow of time.
